(19) United States
(12) Patent Application Publication
(10) Pub. No.: US 2005/0074658 A1
(43) Pub. Date: Apr. 7, 2005

(54) Fuel cells with applied stress and methods of implementing the same

(75) Inventors: Richard Scott Bourgeois, Albany, NY (US); Harish Radhakrishna Acharya, Clifton Park, NY (US); Curtis Alan Johnson, Niskayuna, NY (US); Sauri Gudlavalleti, Albany, NY (US)

Correspondence Address: General Electric Company;CRD Patent Docket Rm 4A59, Bldg. K-1, P.O. Box 8, Schenectady, NY, 12301, US

(73) Assignee: General Electric Company

(21) Appl. No.: 10/679,168

(22) Filed: Oct. 6, 2003

(51) Int. Cl. H01M 8/04; B05D 5/12

(52) U.S. Cl. 429/37; 429/66; 429/26; 427/115

(57) ABSTRACT

A fuel cell assembly comprises a stress inducer for inducing a planar compressive stress, typically at least one stress inducer, in some embodiments, to at least one of an anode layer, a cathode layer and an electrolyte layer interposed therebetween, constructed from brittle layers having a higher fracture strength in compression than in tension. More particularly, the present technique provides a stress inducer for inducing the planar compressive stress to at least one of those brittle layers.

### BACKGROUND OF INVENTION

The present invention relates to fuel cells such as solid oxide fuel cells and particularly to management of thermo-mechanical stress induced therein by way of their manufacture and operation.

A fuel cell is an energy conversion device that produces electricity by electrochemically combining typically a fuel stream and an oxidant stream fed across typical ionic conducting layers being maintained in a thermal environment at a temperature range, for example, between about 600° C. to about 1300° C. The operating layers generally include at least an anode, an electrolyte and a cathode that provide sites for electrochemical reactions between the fuel stream and the oxidant stream in order to enable electricity generation. Generally, the anode, the cathode and the electrolyte are fabricated from ceramic and its composite materials so as to facilitate kinetics of the electrochemical reaction at the reaction sites of these operating layers. However, it may be noted that those operating layers constructed from ceramics and its composite materials have brittle properties. Further, substantial mechanical stress, for example, tensile stress is generally induced across the operating layers as a consequence of the mechanical load arising due to the differential pressure gradient between the fuel stream and the oxidant stream, from stresses related to differential coefficients of thermal expansion (CTE) and due to the mechanical loads generated through the stack from sealing and bonding, for example. Moreover, these operating layers are exposed to a thermal load generated due to hot thermal operating environment of these fuel cells. Such mechanical stress coupled with the thermal load on the operating layers induces a thermo-mechanical stress.

The mechanical stress profile induced across the operating layers is generally a function of the fuel cell geometry and its size or dimensions, particularly a thickness and a width of the operating layers. Operationally, mitigating such a mechanical stress profile induced across the operating layers poses a challenge to the fuel cell designers, particularly with large fuel cells which typically have lower mechanical strength than smaller cells. Under these circumstances, the mechanical stress induced to at least one of those operating layers might fracture or a crack the fuel cell resulting in its failure.

In conventional approaches, restricting the fuel cell size below a maximum pre-determined limit may generally minimize such mechanical stresses and the probability of failure. However, limiting the fuel cell size below such pre-determined limit, may adversely impact the fuel cell performance because power output is directly proportional to the surface area of the operating layers.

Accordingly, there is a need in the related art for mitigating the thermo-mechanical stress induced in the operating layers of the fuel cell without compromising its operational effectiveness, particularly when the fuel cell size is desired to be increased to derive enhanced power output therefrom.

### BRIEF DESCRIPTION

The present technique is designed to effectively respond to such needs. Briefly, in accordance with one aspect of the present technique, a fuel cell assembly comprises a stress inducer for inducing a planar compressive stress, typically at least one stress inducer, in some embodiments, to at least one of an anode layer, a cathode layer and an electrolyte layer interposed therebetween, those layers being constructed of brittle layers having a higher fracture strength in compression than in tension.

A method in accordance with the present technique for inducing a planar compressive stress to at least one of a brittle layer of a fuel cell assembly comprises the steps of providing a reinforcement structure having a first pre-determined coefficient of thermal expansion that supports at least one of an anode layer, a cathode layer and an electrolyte layer interposed therebetween constructed from these brittle layers having a higher fracture strength in compression than in tension and subsequently incorporating those brittle layers over the reinforcement structure at a pre-determined deposition temperature. Typically, the brittle layer comprises materials having a coefficient of thermal expansion different from the coefficient of thermal expansion of the reinforcement structure.

### DRAWINGS

These and other features, aspects, and advantages of the present invention will become better understood when the following detailed description is read with reference to the accompanying drawings in which like characters represent like parts throughout the drawings, wherein:

FIG. 1 is an exploded perspective view of an exemplary fuel cell stack depicting a plurality of fuel cell assemblies in accordance with aspects of the present technique;

FIG. 2 is a diagrammatical view generally representing operation of a typical fuel cell assembly in accordance with aspects of the present technique;

FIG. 3 is a perspective view depicting an arrangement for pre-stressing the fuel cell assembly in accordance with one embodiment of the present technique;

FIG. 4 is another perspective view depicting an arrangement for pre-stressing the fuel cell assembly in accordance with another embodiment of the present technique;

FIG. 5 is another perspective view depicting an arrangement for pre-stressing the fuel cell assembly in accordance with another aspect of the present technique;

FIG. 6 is a plan view of the fuel cell assembly of FIG. 5 depicting a step for pre-stressing thereof conforming to the aspects of FIG. 5;

FIG. 7 is a plan view of the fuel cell assembly of FIG. 5 depicting another step for pre-stressing thereof conforming to the aspects of FIG. 5;

FIG. 8 is another plan view of the fuel cell assembly of FIG. 5 depicting an arrangement for pre-stressing thereof in accordance with another embodiment of the present technique;

FIG. 9 is another plan view of the fuel cell assembly of FIG. 5 depicting an arrangement for pre-stressing thereof in accordance with another embodiment of the present technique;

FIG. 10 is another plan view of the fuel cell assembly of FIG. 5 depicting arrangement for pre-stressing thereof in accordance with another embodiment of the present technique; and

FIG. 11 is a diagrammatical view showing method of pre-stressing the fuel cell assembly in accordance with aspects of the present technique.

### DETAILED DESCRIPTION

Fuel cells, such as solid oxide fuel cells, have demonstrated a potential for high efficiency and low pollution in power generation. Generally, a fuel cell is an energy conversion device that produces electricity by electrochemically combining a fuel and an oxidant across ionic conducting layers. Such fuel cells may further be stacked together either in series or in parallel to produce a desired electrical energy output.

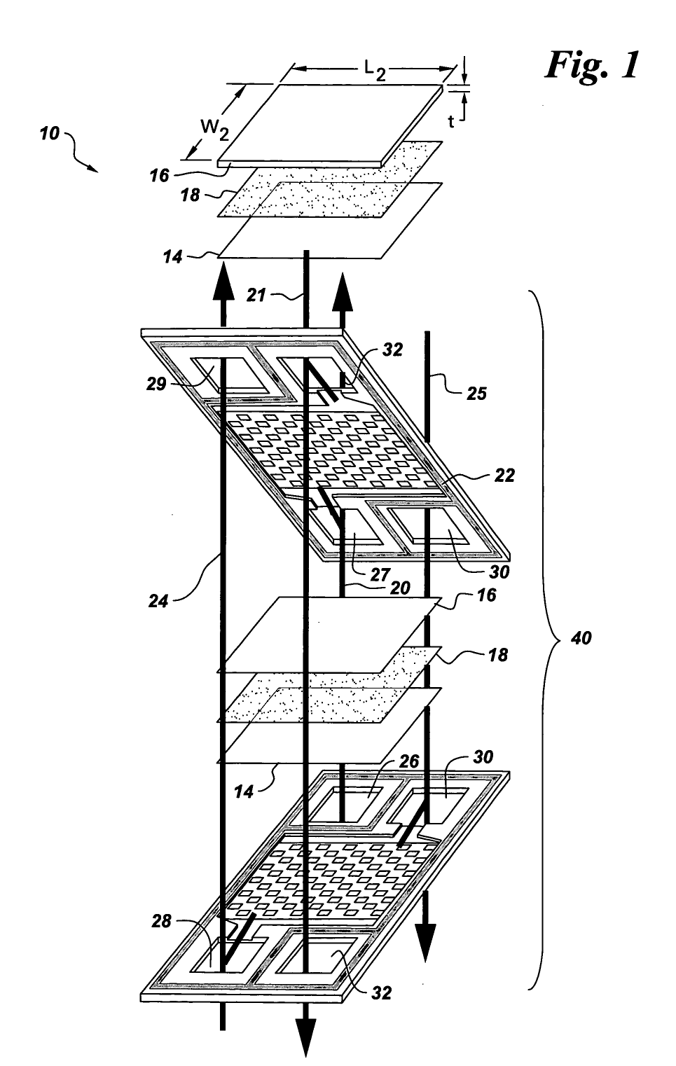

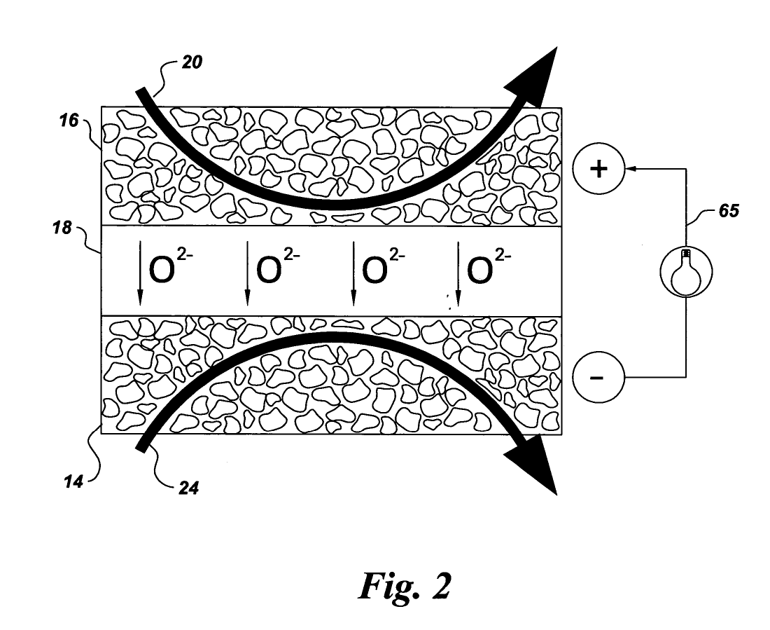

An exploded perspective view of an exemplary fuel cell stack 10, for example a solid oxide fuel cell stack is depicted in FIG. 1. The fuel cell stack 10 includes a plurality of exemplary fuel cell assemblies 40. Each exemplary fuel cell assembly 40 comprises an architecture built from a plurality of operating layers including an anode 14, a cathode 16, an electrolyte 18 interposed therebetween and at least one interconnect 22 configured to maintain intimate contact with at least one of the anode 14, the cathode 16 and the electrolyte 18. In some embodiments, an oxidant stream 20, for example, air stream, is introduced to the cathode 16 through a typical inlet oxidant manifold 26. Further, a fuel 24, for example, natural gas is fed to the anode 14 through at least one inlet fuel manifold 28. Operationally, a plurality of oxygen ions (O²⁻) generated at the cathode 16 are desirably transported across the electrolyte 18 to the anode 14 (see FIG. 2). The fuel 24 introduced at the anode 14 reacts electrochemically with these oxygen ions (O²⁻) to release a plurality of electron streams to an external electric circuit 65 producing electrical power output from each fuel cell assembly 40. In an exemplary embodiment shown in FIG. 1, the oxidant stream 20 may be transported from one fuel cell assembly to another fuel cell assembly of the fuel cell stack 10 via an oxidant passage 27. Similarly, the fuel stream 24 may generally be transported from one fuel cell assembly to another fuel cell assembly via a fuel passage 29. Further, the exhaust gas 25 produced during the electrochemical reaction at the fuel cell assembly 40 is desirably vented through at least one exhaust passage 30. Moreover, an unutilized portion of the oxidant stream 20 (generally indicated by reference numeral 21) may be exhausted or alternatively recycled through another exhaust oxidant passage 32.

It may be appreciated that, the anode 14 and the cathode 16 generally facilitate electrochemical reaction of the fuel 24 introduced into the fuel cell assembly 40. Therefore, the anode 14 materials should desirably be stable enough in the fuel-reducing environment, have adequate electronic conductivity, sufficient surface area available for the electrochemical reactions, relatively fast response to execute catalytic activity for these electrochemical reactions and sufficient porosity to allow gas transport to the reaction sites, for example. More particularly, it may be envisioned that the anode 14 and the cathode 16 should desirably have enough surface area in order to accelerate kinetics of the electrochemical reaction in the fuel cell assembly 40. Further, the materials used for the anode 14 and the cathode 16 should have desirable thermal stability between the typical minimum and maximum operating temperature of the fuel cell assembly 40, for example, between about 600° C. to about 1300° C. Hence, the materials suitable for the anode 14 and the cathode 16 having these desirable properties typically include, but are not limited to, ceramics and its composites such as nickel-yttria-stabilized zirconia cermets (Ni—YSZ cermets), copper-yttria-stabilized zirconia cermets (Cu—YSZ cermets), nickel-ceria cermets and combinations thereof.

The electrolyte 18 disposed between the anode 14 and the cathode 16 desirably transports oxygen ions (O²⁻) between the cathode 16 and the anode 14. The electrolyte 18 is generally fabricated from a material having desirable properties, such as, for example, chemical stability in both reducing and oxidizing environments and adequate electrochemical conductivity at the fuel cell assembly 40 operating conditions. The materials suitable for the electrolyte 18 having those desirable properties, include, without limitation, ceramics and its composites such as zirconium oxide, yttria stabilized zirconia (YSZ), doped ceria, cerium oxide (CeO₂), bismuth sesquioxide, pyrochlore oxides, doped zirconates, perovskite oxide materials and combinations thereof.

Sources of mechanical stress include: CTE mismatch stress arising from mechanical bonding through sealing or otherwise, of the fuel cell to its supporting interconnect having a different CTE at a temperature different from the operating and shut-down temperatures of the unit; stress due to pressure gradients; and stress due to temperature variations in space and time during startup, operation, transients or shutdowns. It may be noted that, the materials constructing the operating layers comprising at least one of the anode 14, the cathode 16 and the electrolyte 18 generally have brittle properties. Operationally, substantial mechanical stress, such as, tensile stress is induced across these operating layers due to the differential pressure gradient between the fuel stream 24 and the oxidant stream 20 flowing through the fuel cell assembly 40. Further, those operating layers constructing the anode 14, the cathode 16 and the electrolyte 18 are exposed to the thermal load resulting due to the hot thermal environment of the fuel cell stack 10, such as, a solid oxide fuel cell stack, for example. In implementation, mitigating excess mechanical stress induced across the operating layers poses issues to the fuel cell assembly 40 designers particularly under circumstances when the fuel cell assembly 40 size or dimensions exceeds a certain pre-determined limit in order to respond to desirability for deriving enhanced power output from these fuel cell assemblies 40. More particularly, such excess mechanical stress induced in the operating layers during fuel cell assembly 40 operation might trigger mechanical fracture or crack at certain local areas thereof, under circumstances, for example, when the locally induced mechanical stress in those operating layers exceeds its permissible limit. This fracture or crack may propagate through the operating layers constructing the fuel cell assembly 40 increasing its failure risk further. Furthermore, such undesirable fracture or crack generated in the operating layers generally degrades the overall reliability of the fuel cell stack 10.

This invention is designed to effectively respond to these issues. It may be noted that, typically the ceramics and its composites constructing these operating layers including at least one of the anode 14, the cathode 16 and the electrolyte 18 are relatively more vulnerable to fail against the tensile stress compared to a compressive stress that may be imposed thereupon. Therefore, in order to mitigate at least a portion of the mechanical tensile stress induced in those operating layers of the fuel cell assembly 40 by way of its operation, some aspects of the present technique are envisaged to design suitable means, for example at least one stress inducer, in some embodiments, for desirably imposing appropriate planar compressive pre-stress profile to at least one of those operating layers building the fuel cell assembly 40, prior to their commissioning and operation.

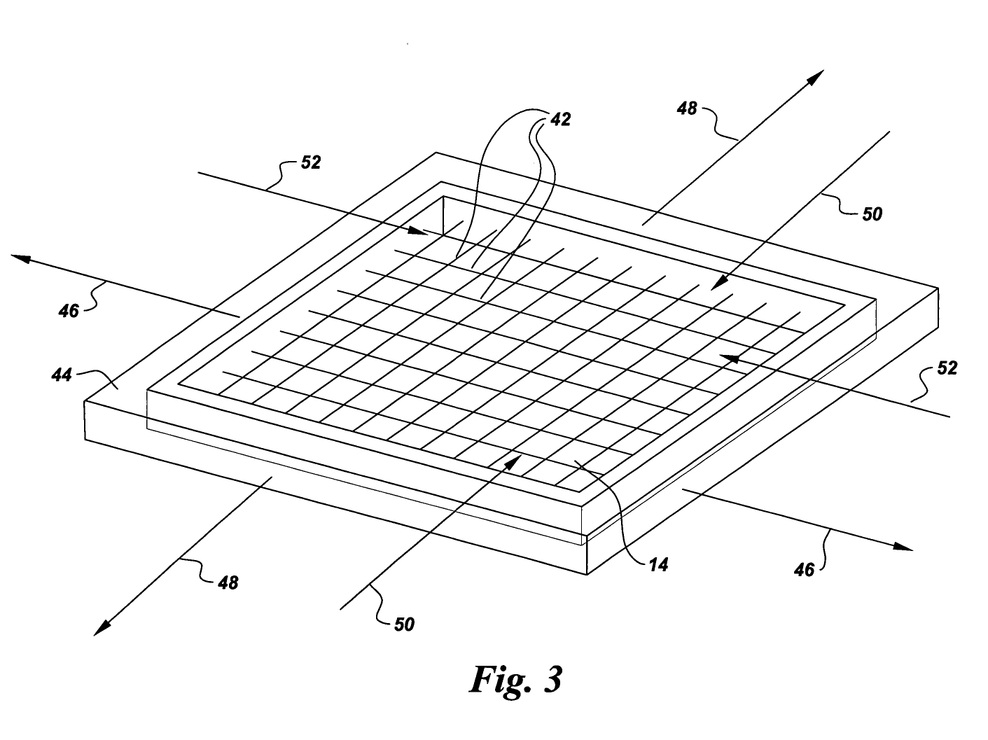

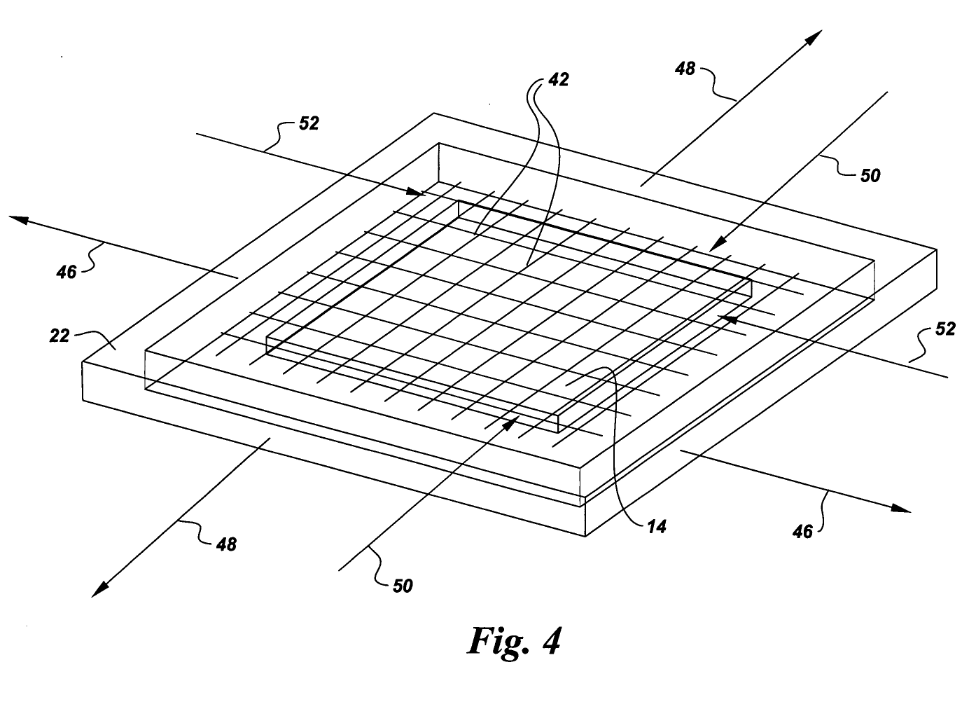

In accordance with one expression of the present technique, a stress inducer 42, for example a plurality of exemplary reinforcement structures are applied to at least one of the operating layers, for example, the anode 14 fabricated from the brittle materials, such as, ceramics or its composites (see FIG. 3). In some embodiments, the reinforcement structures 42 may be embedded within such exemplary operating layer 14. These reinforcement structures 42 may generally be stretched elastically by applying the typical tensile load 46, 48 profile having a pre-determined magnitude and further acting along at least one of the exemplary planar direction shown in FIG. 3. Further, the tensile load 46, 48 may be transferred to the plurality of reinforcement structures 42 via a suitable load applying means, such as, a pre-stressing frame 44. After the tensile load 46, 48 is withdrawn from the load applying means 44, the elastic strain energy released from these reinforcement structures 42 pre-stressed by the tensile load 46, 48 profile induces desirable compressive pre-stress to the exemplary operating layer 14. Such compressive pre-stress may generally include an uniaxial compressive stress induced across a single plane of the exemplary operating layer 14 (generally indicated by reference numeral 50 or 52 by way of example) or a biaxial compressive stress induced across a pair of mutually orthogonal planes thereof (see FIG. 3 and FIG. 4). Alternative configurations of these pre-stressed reinforcement structures 42 may include, without limitation, a wire-structure, a fiber structure, a wire-mesh structure, or a perforated sheet structure. Choosing suitable configuration of those pre-stressed reinforcement structures 42 depends on trade-off relationship among factors, such as, its dead load, ability to resist plastic deformation under the pre-determined tensile load 46, 48 and ease of manufacturing, for example. In another embodiment depicted in FIG. 4, those reinforcement structures 42 are applied to another layer, for example, the interconnect 22 that maintains intimate contact with at least one of those operating layers (i.e. the anode 14 the cathode 16 and the electrolyte 18). Operationally, in accordance with present embodiment, the interconnect 22 is generally stretched elastically by the tensile load 46, 48 and further transfers such tensile load 46, 48 profile to the reinforcement structures 42 for inducing pre-stress therein. Further, after withdrawing the tensile load 46, 48 from the interconnect 22, the elastic strain energy released from the reinforcement structures 42 pre-stressed by the tensile load 46, 48 induces the desired compressive pre-stress profile to the exemplary operating layer 14.

In accordance with another expression of the present technique, the exemplary reinforcement structure 22 such as the interconnect 22 is introduced to the operating layer, such as, for example, the anode 14 (see FIG. 5). In implementation, the reinforcement structure 22 may include any structure, such as metallic frames, for example, having the physical properties substantially similar to the interconnect 22. Typically, the interconnect 22 should desirably withstand operating temperature range of the fuel cell assembly 40, for example, between about 600° C. to about 1300° C., be passive against oxidation in the oxidizing environment, be stable in fuel reducing environment and have adequate electrical conductivity in the operating temperature range of the fuel cell assembly 40. Therefore, the interconnect 22 is generally fabricated from materials having those desirable properties, including, but not limited to, chromium based ferritic stainless steel, cobaltite, Inconel 600, Inconel 601, Hastelloy X, Hastelloy-230 and combinations thereof. Further, the interconnect 22 may desirably be configured to provide a reinforcement structure for depositing at least one of the operating layer i.e. the anode 14, the cathode 16 and the electrolyte 18 materials. Accordingly, in some embodiments, the operating layers of the fuel cell assembly 40 are generally formed by “layer-after-layer” deposition of the materials constructing those operating layers on the interconnect 22.

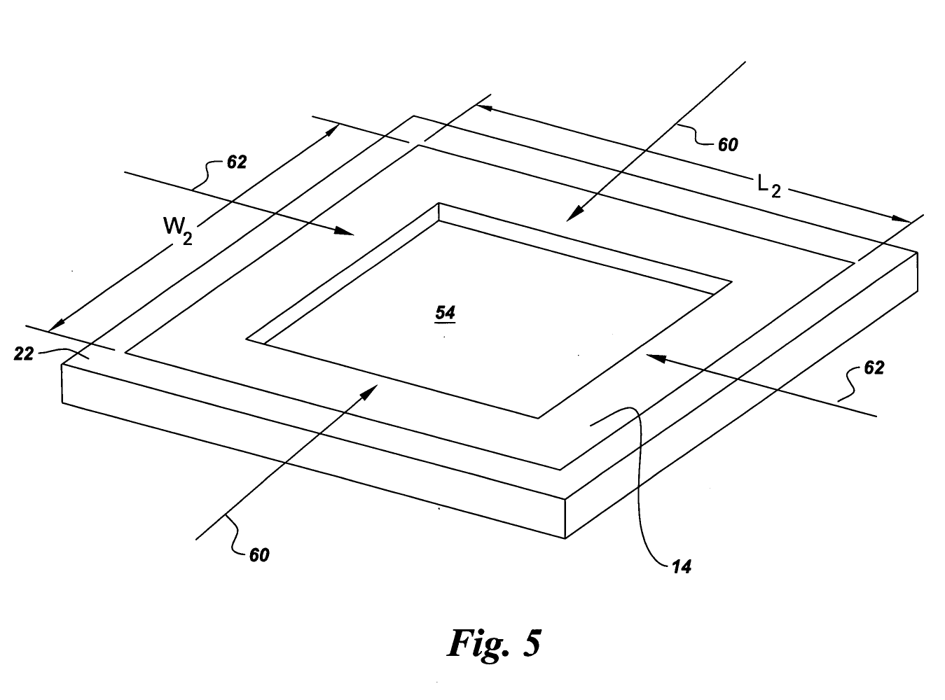

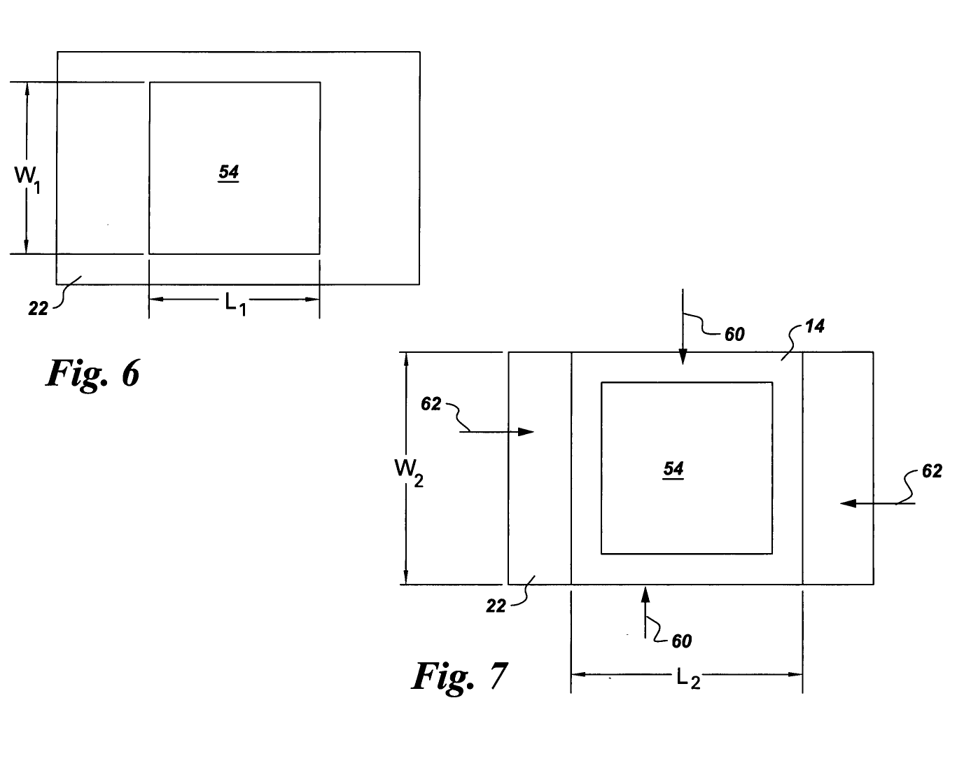

In accordance with present expression of the current technique, a pre-determined coefficient of thermal expansion (αᵢₙₜ) of the material constructing the reinforcement structure, for example, the interconnect 22 is appropriately chosen to be different from the coefficient of thermal expansion (α_{cell}) of the exemplary operating layer 14 materials, such as ceramics. More particularly, the pre-determined coefficient of thermal expansion (αᵢₙₜ) of the materials constructing the interconnect 22 is desirably chosen to be greater than the coefficient of thermal expansion (α_{cell}) of the operating layer materials (i.e. the anode 14 materials for example). Turning to FIG. 6, the interconnect 22 is generally configured to typically define a space 54 characterized by a length “L₁” and an width “W₁” for receiving the materials to be deposited thereupon for building the exemplary operating layer 14 architecture. Interconnect 22 is in contact with operating layer 14 over a portion of space 54, and the remainder is open to allow transmission of gases, for example inlet fuel stream 24, through the interconnect 22 to the surface of operating layer 14. Typically the “open” and “closed” areas of space 54 are arranged in a repeating pattern such as for example a grid of squares or circles. The width “W₁” of space 54 is therefore the sum of several widths of open areas “W_{O}” and of closed areas “W_{C}.” Next, referring to FIG. 7, the materials constructing the operating layers are generally deposited at a “pre-determined deposition temperature T_{P}” typically greater than an “operational temperature T_{O}” of the fuel cell assembly 40. As used herein, the term “operational temperature T_{O}” refers to the possible temperature range that the fuel cell assembly 40 might be exposed to during its lifespan under operating as well as non-operating conditions, for example, during its storage, shipping and standby conditions. The “operational temperature T_{O}” range, typically between about 0° C. to about 1300° C. may be appropriately chosen by the exemplary fuel cell assembly 40 designers with due consideration to the constraints arising due to ambient thermal environment surrounding those fuel cell assemblies 40 as well as the internal thermal environment thereof during its operating condition. In implementation, during cooling of the interconnect 22 as well as the exemplary operating layer 14 deposited thereon, typically from the “pre-determined deposition temperature T_{P}” to the “operational temperature T_{O},” the exemplary operating layer 14 generally shrinks at a significantly slower rate compared to the shrinkage rate of the interconnect 22 due to substantial difference between the pre-determined coefficient of thermal expansion (αᵢₙₜ) of the interconnect 22 and the coefficient of thermal expansion (α_{cell}) of the exemplary operating layer 14. The differential shrinkage rate between the exemplary operating layer 14 and the interconnect 22 during cooling thereof typically from the “deposition temperature T_{P}” to the “operational temperature T_{O}” results in mechanical strain, thus imposing the desired compressive pre-stress (σ_{comp}) 60, 62 profile on these operating layers 14 (see FIG. 7). The magnitude of this compressive pre-stress (σ_{comp}) may be generally estimated from the equation as appended below.
σ_{comp}=E/(1−υ)*(αᵢₙₜ−α_{cell})*(T_{P}−T_{O})
E=Young's modulus of the material constructing the operating layers.
υ=Poisson's ratio of the material constructing the operating layers.
   In some embodiments where the deposition temperature T_{P}” is less than the “operational temperature T_{O},” the coefficient of thermal expansion (αᵢₙₜ) of the interconnect 22 will be desirably chosen to be less than the coeficcient of thermal expansion (α_{cell}) of the exemplary operating layer 14 such that the resulting pre-stress will be compressive when the fuel cell stack is heated from temperature T_{P} to temperature T_{O}.

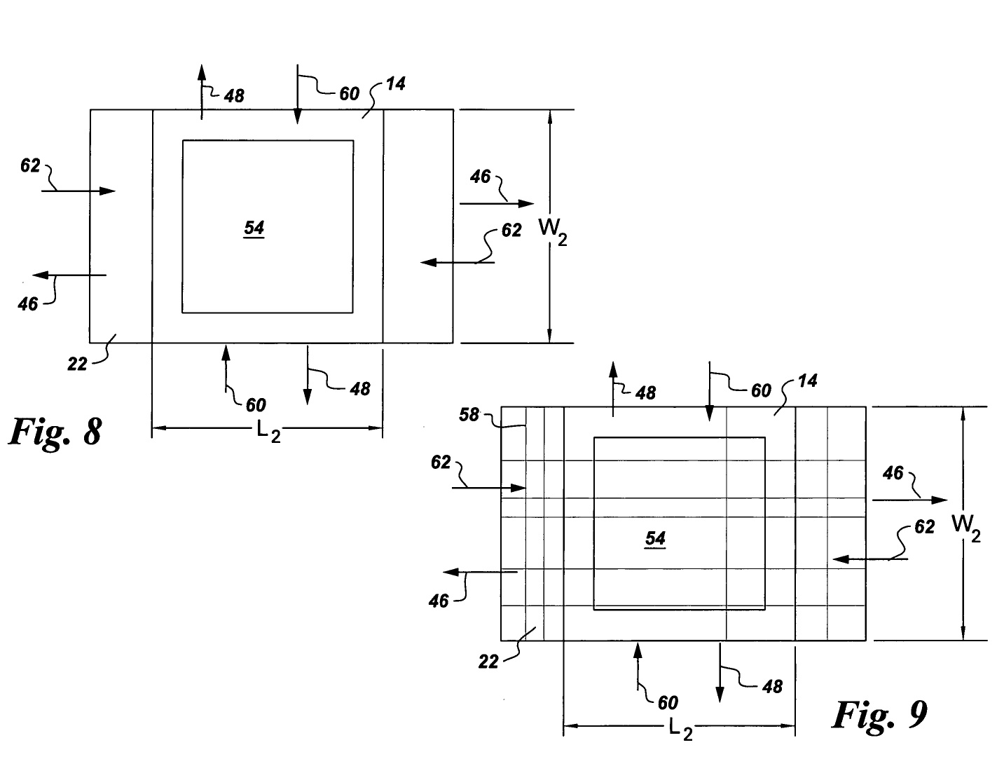

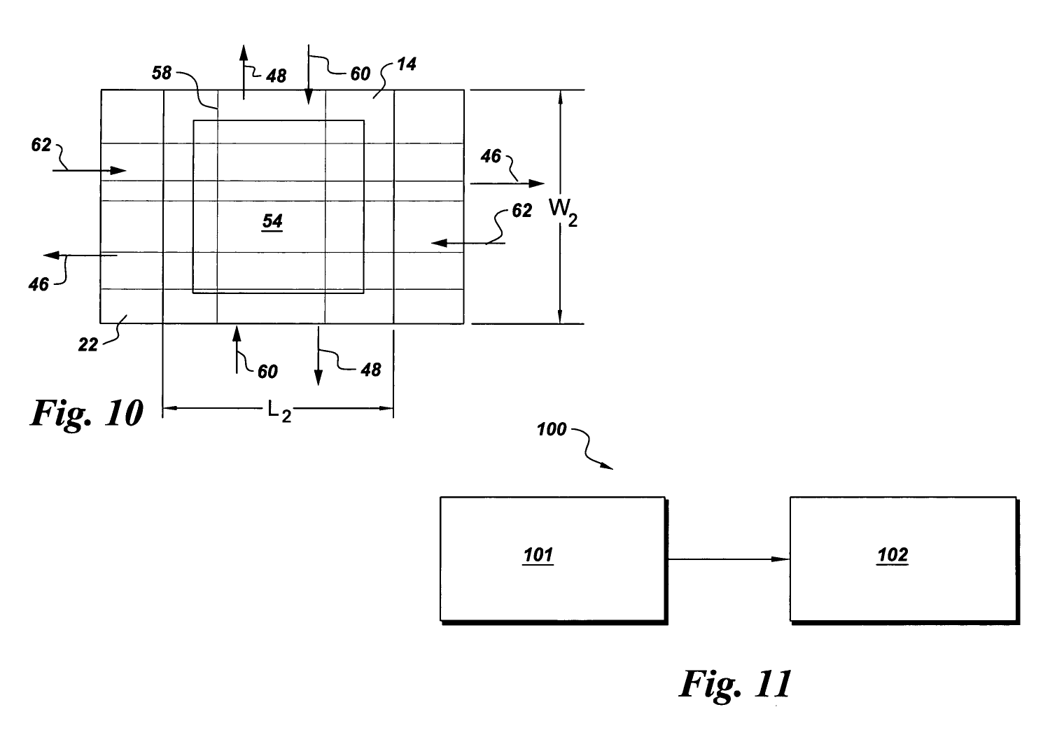

In some alternative embodiment of the present expression, the interconnect 22 may be further stretched elastically by applying the exemplary tensile load 46, 48 thereupon (see FIG. 8). Typically, such tensile stretching is performed prior to the deposition of the exemplary operating layer 14 materials on the interconnect 22. After the tensile load 46, 48 is withdrawn, the interconnect 22 pre-stressed by such tensile load 46, 48 profile generally releases elastic strain energy to the exemplary operating layer 14 via the interconnect 22 to further enhance the compressive pre-stress 60, 62 induced to the exemplary operating layer 14. According to another alternative embodiment of the present expression, the reinforcement structure, such as, the interconnect 22 further comprises a plurality of additional reinforcement structures 58 (see FIG. 9). In some other embodiment, those additional reinforcement structures 58 are applied to the exemplary operating layer 14 (see FIG. 10). These additional reinforcement structures 58 may include, without limitation, at least one of the wire-structure, the fiber structure, the wire-mesh structure, or the perforated sheet structure.

The magnitude of the compressive pre-stress 50, 52, 60, 62 induced to the exemplary operating layer 14 may be adjusted to be limited below certain desirable pre-determined limit by altering some factors that influence its magnitude, such as, the tensile load 46, 48 applied to the operating layers, the difference between the coefficient of thermal expansion of the material constructing reinforcement structure (for example the interconnect 22) and the operating layer (i.e. αᵢₙₜ−α_{cell}); the difference between the “pre-determined deposition temperature T_{P}” and the “operational temperature T_{O}” (i.e. T_{P}−T_{O}), for example. In general, those operating layers are configured to maintain the pre-determined thickness “t” and the width “W₂” (see FIG. 1 and FIG. 5) in order to conform to a desired operational effectiveness of the fuel cell assembly 40. The operating layers are supported by their contact with interconnect 22. Portions of the operating layers in contact with the interconnect 22 are not subject to buckling. The portion of the operating layers subject to buckling are characterized by the thickness of the operating layer “t” and the width “W_{O}” of the areas not in contact with the interconnect 22. In operation, adjusting the compressive pre-stress below the pre-determined limit desirably prevents buckling that might result from the compressive pre-stress imposed on the operating layers maintained at the predetermined thickness “t” and the width “W₂.” This compressive pre-stress may desirably be adjusted further in such a manner that all of the tensile stress induced across the exemplary operating layer 14 by way of the fuel cell assembly 40 operation may be substantially negated by the compressive pre-stress such that the reinforcement structures, for example, the interconnect 22 connected to the exemplary operating layer 14 is in a substantially stress-free state. As used herein, the term “substantially stress-free state” implies little or insignificant residual stress that may remain in the interconnect 22 connected to the exemplary operating layer 14 during operation of the fuel cell assembly 40. As a consequence thereof, the ratio of the pre-determined thickness “t” and the width “W_{O}” of the exemplary operating layer 14 may desirably be maintained in the range, for example, between about 0.01 to about 1 without compromising the structural stability of the fuel cell assembly 40 while responding to the desirability to derive enhanced power output therefrom.

A method expression 100 for inducing a planar compressive stress to at least one of a brittle layer of a fuel cell assembly is summarily depicted in FIG. 11. Operationally, this method expression includes a first step 101 of providing a reinforcement structure, for example, the interconnect 22 configured to support at least one of the anode 14 layer, the cathode 16 layer and the electrolyte 18 layer interposed therebetween. It may be noted that at least one of these layers 14, 16, 18 (i.e. the operating layers) is constructed from typical brittle materials having a higher fracture strength in compression compared to tension. At a next step 102 at least one of these layers 14, 16, 18 are deposited over the reinforcement structure (i.e. the interconnect 22 in some embodiments) at a “pre-determined deposition temperature T_{P}.” The operating layer, for example, the anode 14 comprises a material having a coefficient of thermal expansion (α_{cell}) appropriately chosen to be different from the pre-determined coefficient of thermal expansion (αᵢₙₜ) of the material constructing the reinforcement structure, such as, the interconnect 22. More particularly, the pre-determined coefficient of thermal expansion (αᵢₙₜ) of the interconnect 22 materials is desirably chosen to be greater than the coefficient of thermal expansion (α_{cell}) of the operating layer materials (i.e. the anode 14 materials for example). The aspects characterizing various embodiments of the means to induce the compressive pre-stress across at least one of those operating layers 14, 16, 18 in accordance with this method expression are identical to the aspects discussed in preceding paragraphs.

It will be apparent to those skilled in the art that, although the invention has been illustrated and described herein in accordance with the patent statutes modification and changes may be made to the disclosed embodiments without departing from the true spirit and scope of the invention. It is, therefore, to be understood that the appended claims are intended to cover all such modifications and changes as fall within the true spirit and scope of the invention.

1. A fuel cell assembly comprising:
an anode layer, a cathode layer and an electrolyte layer interposed therebetween; wherein at least one of said layers comprises a brittle layer having a higher fracture strength in compression than in tension; and
a stress inducer for inducing a planar compressive stress to at least one of said brittle layers.

2. The fuel cell assembly in accordance with claim 1, wherein said compressive stress comprises a uniaxial compressive stress induced across at least one local plane of said brittle layer.

3. The fuel cell assembly in accordance with claim 1, wherein said compressive stress comprises a biaxial compressive stress induced within the plane of said brittle layer.

4. The fuel cell assembly in accordance with claim 1, wherein said stress inducer for inducing said compressive stress comprises a prestressed reinforcement structure applied to said brittle layer.

5. The fuel cell assembly in accordance with claim 4, wherein said prestressed reinforcement structure is embedded within said brittle layer.

6. The fuel cell assembly in accordance with claim 4, wherein said prestressed reinforcement structure is applied to a second layer other than said brittle layer.

7. The fuel cell assembly in accordance with claim 6, wherein said prestressed reinforcement structure comprises at least one of a wire-structure or a fiber structure, or a wire-mesh structure, or a perforated sheet structure.

8. The fuel cell assembly in accordance with claim 1, wherein said stress inducer for inducing said compressive stress comprises a reinforcement structure applied to said brittle layer wherein said reinforcement structure has a first pre-determined coefficient of thermal expansion different from a pre-determined coefficient of thermal expansion of said brittle layer.

9. The fuel cell assembly in accordance with claim 8, wherein said first pre-determined coefficient of thermal expansion of said reinforcement structure is greater than said pre-determined coefficient of thermal expansion of said brittle layer; the reinforcement structure being adapted to said brittle layer at a temperature greater than an operational temperature of said brittle layer.

10. The fuel cell assembly in accordance with claim 8, wherein said reinforcement structure comprises an interconnect, wherein said brittle layer is applied on said interconnect at a pre-determined deposition temperature greater than an operational temperature of said brittle layer wherein the interconnect has a first pre-determined coefficient of thermal expansion greater than said coefficient of thermal expansion of said brittle layer.

11. The fuel cell assembly in accordance with claim 10, wherein said reinforcement structure is connected to said brittle layer in a substantially stress-free state.

12. The fuel cell assembly in accordance with claim 11, wherein said reinforcement structure further comprises at least one of a wire-structure, or a fiber structure or a wire mesh structure or a perforated sheet structure

13. The fuel cell assembly in accordance with claim 12, wherein said reinforcement structure is applied to said brittle layer.

14. The fuel cell assembly in accordance with claim 1, wherein the ratio of said pre-determined thickness and said unsupported width of said brittle layer is in the range from about 0.01 to about 1.

15. A fuel cell assembly comprising:
an anode layer, a cathode layer and an electrolyte layer interposed therebetween; wherein at least one of said layers comprises a brittle layer having a higher fracture strength in compression than in tension; and
a stress inducer for inducing a planar compressive stress to at least one of said brittle layers having a pre-determined thickness and a width;
wherein said stress inducer comprises an interconnect configured to be in intimate contact with at least one of said brittle layers;
wherein said brittle layer is applied on said interconnect at a pre-determined temperature greater than an operational temperature of said brittle layer wherein the interconnect has a first pre-determined coefficient of thermal expansion greater than said coefficient of thermal expansion of said brittle layer.

16. A fuel cell assembly 40 comprising:
an anode layer 14, a cathode layer 16 and an electrolyte layer 18 interposed therebetween;
wherein at least one of said layers comprises a brittle layer having a higher fracture strength in compression than in tension;
and a stress inducer 42 for inducing a planar compressive stress to at least one of said brittle layers having a pre-determined thickness and a width; wherein said stress inducer 42 comprises an interconnect 22 configured to be in intimate contact with at least one of said brittle layers; wherein said brittle layer is applied on said interconnect 22 at a pre-determined deposition temperature less than an operational temperature of said brittle layer wherein the interconnect 22 have a first pre-determined coefficient of thermal expansion less than said coefficient of thermal expansion of said brittle layer.

17. A method for inducing a planar compressive stress to at least one of a brittle layer of a fuel cell assembly comprising the steps of:
providing a reinforcement structure having a first pre-determined coefficient of thermal expansion to support at least one of an anode layer, a cathode layer and an electrolyte layer interposed therebetween;
wherein at least one of said layers comprises a brittle layer having a higher fracture strength in compression than in tension; and
depositing said brittle layer over said reinforcement structure at a pre-determined deposition temperature wherein the brittle layer comprises a material having a coefficient of thermal expansion different from said first pre-determined coefficient of thermal expansion of said reinforcement structure.

18. The method in accordance with claim 17, wherein said first pre-determined coefficient of thermal expansion of said reinforcement structure is greater than said coefficient of thermal expansion of said brittle layer; the reinforcement structure being connected to said brittle layer at a temperature greater than an operational temperature of said brittle layer.

19. The method in accordance with claim 17, wherein said reinforcement structure is connected to said brittle layer in a substantially stress-free state.

20. The method in accordance with claim 17, wherein said reinforcement structure comprises an interconnect configured to maintain intimate contact with at least one of said brittle layers.

21. A fuel cell assembly comprising:
an anode layer, a cathode layer and an electrolyte layer interposed therebetween; wherein at least one of said layers comprises a brittle layer having a higher fracture strength in compression than in tension; and
at least one stress inducer for inducing a planar compressive stress to at least one of said brittle layers.
